(19) United States
(12) Patent Application Publication
(10) Pub. No.: US 2016/0202388 A1
(43) Pub. Date: Jul. 14, 2016

(54) CUMULATIVE FLUID FLOW THROUGH OILFIELD IRON ENABLED BY RFID

(71) Applicant: HALLIBURTION ENERGY SERVICES, INC., Houston, TX (US)

(72) Inventors: Lawrence A. Herndon, Duncan, OK (US); Michael E. Malone, Fulshear, TX (US); Keith A. Frost, Marlow, OK (US)

(21) Appl. No.: 14/912,151

(22) PCT Filed: Sep. 18, 2013
(86) PCT No.: PCT/US13/60369

§ 371 Date: Feb. 15, 2016

(51) Int. Cl. G01V 15/00; E21B 47/00

(52) U.S. Cl. CPC G01V 15/00; E21B 47/00

(57) ABSTRACT

Systems and methods for tracking use and status of “discharge manifold equipment (DME)” are disclosed comprising associating a unique identifier to at least one DME, associating a pumping unit identifier to a pumping unit, pumping fluid through the DME, sending the unique identifier associated with the at least one DME and job information associated with the pumping unit to a central database. The central database may compute corrosion and erosion calculations associated with the at least one DME and send the calculations, job information, and/or installation information to a remote device.

### BACKGROUND

The present invention relates generally to operations performed and equipment utilized in conjunction with a subterranean well and, in particular, to tracking use of equipment in wellhead manifolds.

Development and production of fluid from an oilfield requires numerous pieces of piping, tools, and other oil field assets and equipment. Typically, the various types of piping used in the production of fluid from an oil field are iron, or an iron-based composite, and are referred to generically as “iron,” “oilfield iron,” or more correctly “discharge manifold equipment (DME)”. Hereinafter this piping equipment will be referred to as DME. DME and other assets have a limited lifetime for use in well production and degrade during the course of use. In order to account for this degradation, old and/or used DME is typically replaced with new or lesser used DME during the course of a well's production. Accordingly, it is desirable to optimally use and/or reuse DME and dispose of DME that has been overused.

### FIGURES

Some specific exemplary embodiments of the disclosure may be understood by referring, in part, to the following description and the accompanying drawings.

FIG. 1 illustrates an example manifold system that incorporates one or more principles of the present disclosure, according to aspects of the present disclosure.

FIG. 2 shows an example section of a manifold system with identifier tag labeled DME, according to aspects of the present disclosure

FIG. 3 shows an example identifier tag reader used to read an identifier tag, according to aspects of the present disclosure.

FIG. 4 illustrates an example look up screen of a remote device used to receive DME information, according to aspects of the present disclosure.

FIG. 5 illustrates example radiation patterns of the identifier tags allowing the tag to be read, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present invention relates generally to operations performed and equipment utilized in conjunction with a subterranean well and, in particular, to tracking use of DME equipment in wellhead manifolds.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

The terms “couple” or “couples” as used herein are intended to mean either an indirect or direct connection. Thus, if a first device couples to a second device, that connection may be through a direct connection, or through an indirect mechanical or electrical connection via other devices and connections. The term “uphole” as used herein means along the drillstring or the hole from the distal end towards the surface, and “downhole” as used herein means along the drillstring or the hole from the surface towards the distal end.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, multilateral, u-tube connection, intersection, bypass (drill around a mid-depth stuck fish and back into the well below), or otherwise nonlinear wellbores in any type of subterranean formation. Embodiments may be applicable to injection wells, and production wells, including natural resource production wells such as hydrogen sulfide, hydrocarbons or geothermal wells; as well as borehole construction for river crossing tunneling and other such tunneling boreholes for near surface construction purposes or borehole u-tube pipelines used for the transportation of fluids such as hydrocarbons. Embodiments described below with respect to one implementation are not intended to be limiting.

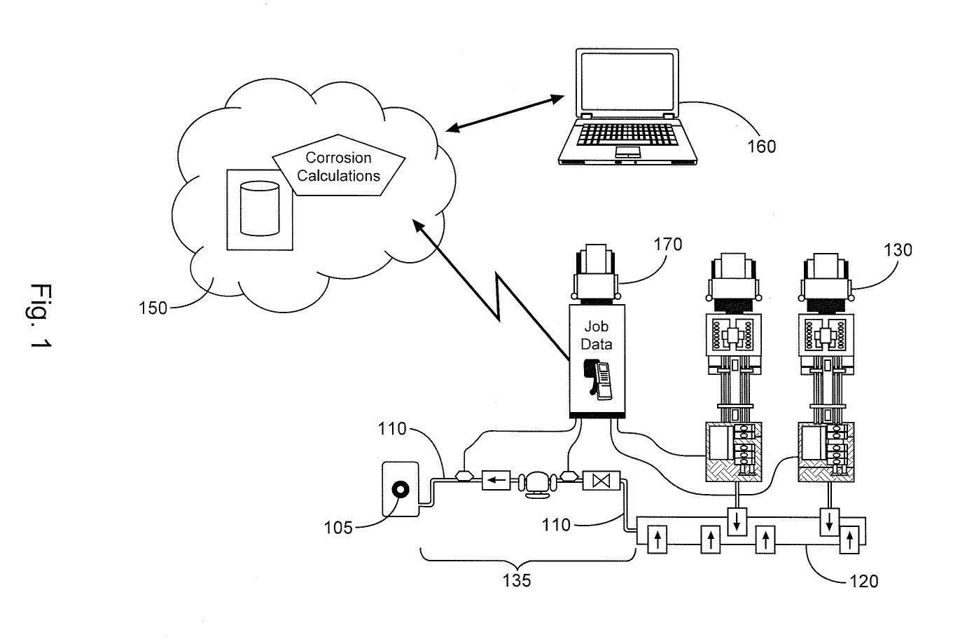

Referring to FIG. 1, illustrated is an example oilfield pumping manifold system 100, according to aspects of the present disclosure. The manifold system 100 may be comprised of a wellhead 105, a DME manifold to wellhead section 135, and a DME manifold 120. The DME manifold to wellhead section 135 may be comprised of a plurality of DME 110 used to direct fluid from the DME manifold 120 to the wellhead 105. For example, the DME 110 may include pipes, valves, tees, elbows, adapters or changeovers, blanks and blanking assemblies, swiveling connectors (usually called “swivel joints”), chokes (a reduced inside flow device), ball injectors and droppers, and/or pressure sensors (transducers). A pumping unit 130 may be connected to the DME manifold 120 to pump fluid from a storage device (not shown) through the DME manifold 120, through wellhead section 135, and to the wellhead 105. In certain embodiments, the pumping unit 130 may be a pump truck, a pumping trailer, or any other unit suitable for directing fluid through the DME manifold 120.

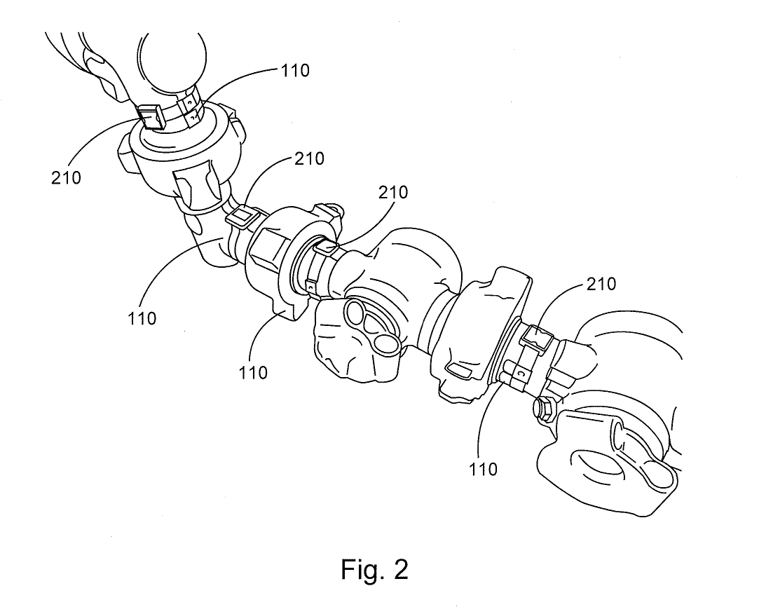

Referring now to FIG. 2, an example region of the DME manifold to wellhead section 135 is illustrated. An identifier tag 210 may be attached to each DME 110. Each identifier tag 210 may contain a unique identifier 501 associated with the tagged DME 110. The unique identifier 501 may be associated with any oilfield asset desired to be tracked, where a different unique identifier 501 may be associated with each asset. In certain embodiments, the unique identifier 501 may be associated with at least one DME 110 and at least one pumping unit 130.

The identifier tag 210 may be attached to the exterior of the DME 110 by strapping the identifier tag 210 to the DME 110, embedding the identifier tag 210 in the DME 110 by installing the identifier tag in a hole, depression, or surface location in or on the DME 110, or through any other means for physically connecting the identifier tag 210 with the associated DME 110. In certain embodiments, the identifier tag 210 may be any commercially available RFID chips or tags. In addition, the identifier tag 210 may be embedded using commercially available adhesive to retain the identifier tag 210 within or to the DME 110.

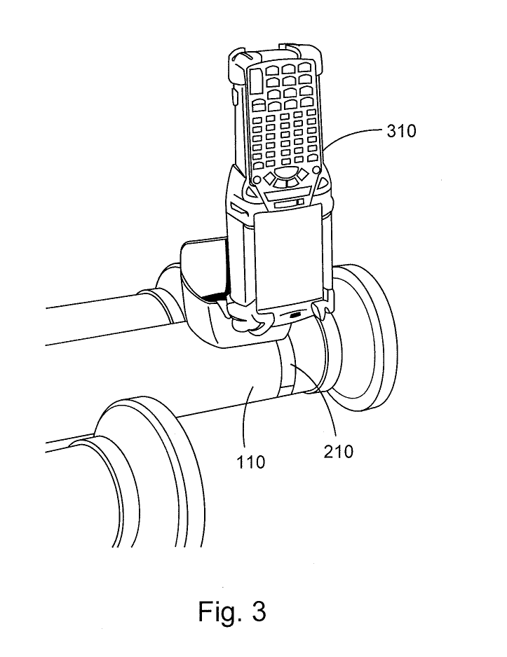

Referring to FIG. 3, the identifier tag 210 may be read by an identifier tag reader 310. In certain embodiments the identifier tag reader 310 may be a standard warehouse bar code scanner with RFID antenna attachment or any other handheld device configured to read the identifier tag 210. For example, the identifier tag reader 310 may be a Motorola 9090z or a Motorola 9190z.

Referring again to FIG. 1, a central database 150 may be configured to receive the unique identifier 501 associated with each pumping unit 130 and DME 110. In certain embodiments, the unique identifier 501 associated with the pumping unit 130 may be in an identifier tag 210 located on the pumping unit 130. In certain embodiments, the identifier tag 210 located on the pumping unit 130 may be an RFID tag. In certain embodiments, the unique identifier 501 associated with the pumping unit 130 may be transmitted to a central database 150 directly or via a mobile command center 170.

The central database 150 may store the information encoded in the unique identifier 501, an example of which is shown in FIG. 5. In certain embodiments, the identifier tag reader 310 may communicate directly with the central database 150. In certain embodiments, the identifier tag reader 310 may communicate with a remote device 160. In certain embodiments, the remote device 160 may be a computer, tablet, handheld device, RFID reader, or other device suitable for receiving and viewing information. In certain embodiments, the identifier tag reader 310 may communicate with the mobile command center 170. The identifier tag reader 310 may transmit information including the unique identifier 501, the date and time of the scan, the location of the scan, and/or the status of the DME. Information transmitted to the central database 150 may be done in real time when the identifier tag 210 is scanned and the unique identifier 501 is received by the identifier tag reader 310, or in a batch after the identifier tags 210 are scanned.

The pumping unit 130 and/or the mobile command center 170 may track the type, pressure, amount, and flow rate of fluid pumped through the pumping unit 130 during the job (hereinafter called “job information”). The pumping unit 130 may send job information to a mobile command center 170 and/or a central database 150. In certain embodiments, the mobile command center 170 may transmit job information to the central database 150 in real-time or in batch mode. The job information may be associated with each DME 110 used in the DME manifold to wellhead 135 during the pump job. The central database 150 may be configured to compute corrosion and erosion calculations for the DME 110 using the job information associated with each DME 110.

Inventory of the DME 110 may be taken by associating the identifier tag 210 to the piece of DME 110 to which the identifier tag 210 may be attached. As each DME 110 is installed in the DME manifold to wellhead section 135, the identifier tag 210 associated with each DME 110 may be scanned and the unique identifier 501 and an installation status may be communicated to a central database 150. In addition, as each DME 110 is removed from the DME manifold to wellhead section 135, the identifier tag 210 associated with each DME 110 may be scanned and the unique identifier 501 and a storage status may be communicated to a central database 150. Thus, the central database 150 may contain an inventory of each DME 110 associated with an identifier tag 210 and the installation status, associated manifold system, date of installation for each tagged DME 110, and/or any other type of information associated with the DME 110 that is desired to be tracked.

As each pumping unit 130 begins operation at the manifold system 120, the unique identifier 501 associated with the pumping unit 130 may be scanned and/or communicated to the central database 150. Job information for each pumping unit 130 may also be communicated to the central database 150. Job information may include the type, pressure, amount, and flow rate of fluid pumped, identification of the manifold, the date and time of job start, the date and time of job finish, and/or any other information desired to track. The central database 150 may associate the job information to each DME 110 listed in the central database 150 as installed at the specific manifold system 120.

The central database 150 may use the job information to track the actual operation time for each DME 110 and/or the total amount of fluid flow through each DME 110. The DME 110 usage information may be accessible by a remote operator through a remote device 160. The central database 150 may perform corrosion and erosion calculations and communicate estimated percentage use and time of replacement information to the remote device 160. As such, an operator using the remote device 160 may track the DME 110 and use the DME 110 corrosion and erosion calculations to determine whether any DME 110 should be replaced and/or plan for the future replacement of DME 110.

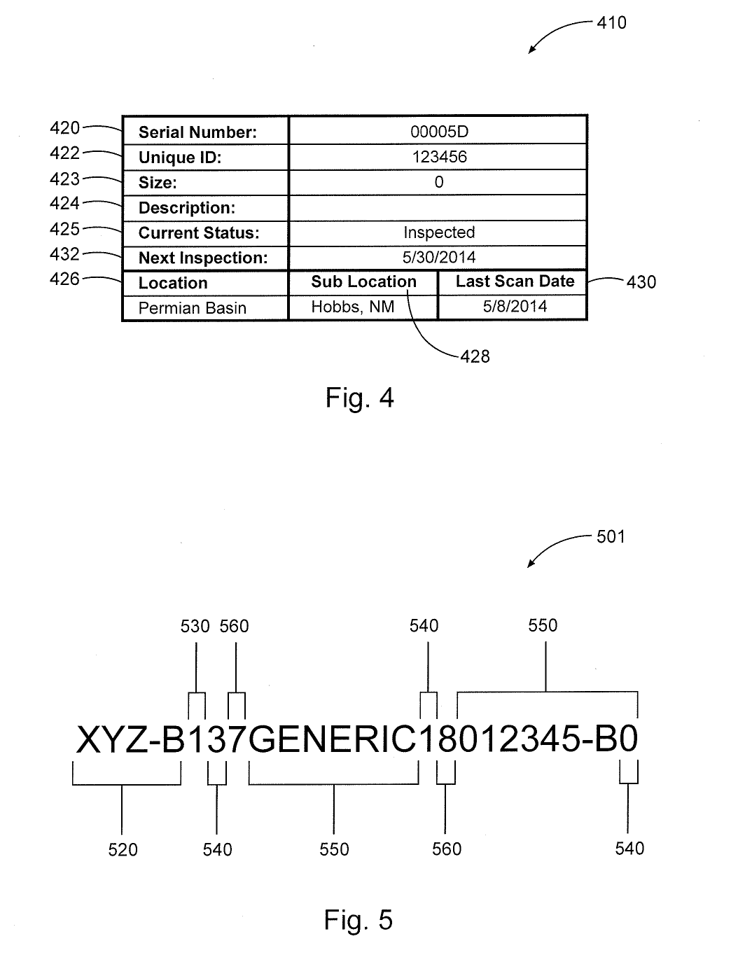

Referring now to FIG. 4, an example look up screen 410 of a remote device 160 is shown. The remote device 160 may allow the operator to communicate with the central database 150. An operator may use the remote device 160 to access data associated with each DME 110. In certain embodiments, the look up screen 410 may include serial number 420, unique identifier 422, size 423, description 424, current status 425, location 426, sub-location 428, last scan date 430, next scheduled date of inspection 432, and/or other use information. In certain embodiments, the current status 425 may include installation information and/or inspection information.

Referring now to FIG. 5, an example unique identifier 501 is shown. The unique identifier 501 may be a unique alpha-numeric code with a fixed length. The unique identifier 501 may contain information for asset type, asset serial number, asset manufacturer, and any other information that may be useful to associate with a specific item of DME 110. In one embodiment, the unique identifier 501 may be made up of a number of data sections, where each data section contains a specific type of information. Unique identifier data sections may be in various positions within the unique identifier 501. In certain embodiments of the unique identifier, a protocol ID section 520 may denote the protocol used by the unique identifier 501. A DME 110 class section 530 of the unique identifier 501 may identify the class of the DME 110. In certain embodiments, the DME 110 class section 530 may include a designation for DME 110, pumping unit, or any other asset class which may be desired to track. A data load type section 540 may identify the type of data contained in the following actual data section 550. A data load length section 560 may contain the number of characters contained in the following actual data section 550. The actual data section 550 may contain any data associated with the asset that would be desired to communicate, including manufacturer and serial number. In other embodiments, the unique identifier 501 may contain a unique code associated with a specific DME 110 in the central database 150.

In one embodiment, the present disclosure provides a method of tracking the use of DME, comprising: providing a DME, attaching an identifier tag to the exterior of the DME, the identifier tag containing a unique identifier, reading the identifier tag with an identifier tag reader, sending the unique identifier to a central database; storing the unique identifier in the central database, providing a pumping unit, associating a pumping unit identifier with the pumping unit, reading the pumping unit identifier with the identifier tag reader, and sending the pumping unit identifier and pumping unit job information to the central database.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A system for tracking the use of DME, comprising:
an at least one DME;
an at least one identifier tag storing a unique identifier, the identifier tag being attached to the at least one DME;
a reader capable of reading the at least one identifier tag and receiving the unique identifier associated with the identifier tag; and
a central database configured to receive and store an identifier tag information from the reader.

2. The system of claim 1, wherein the central database is further configured to receive and store at least one type of information from the reader selected from the group consisting of: installation status, installation status date, inspection status, location, and manifold identification.

3. The system of claim 1, further comprising:
a pumping unit configured to pump fluid through the at least one DME;
a pumping unit identifier tag storing a pumping unit identifier, the pumping unit identifier tag being attached to the pumping unit,
wherein the reader is configured to read the pumping unit identifier tag and receiving the pumping unit identifier associated with the pumping unit identifier tag.

4. The system of claim 3, wherein the central database is further configured to receive and store at least one type of job information selected from the group consisting of: manifold identification, job start date and time, job end date and time, and pumped fluid type, pressure, amount, and flow rate.

5. The method of claim 4, wherein the central database is configured to compute corrosion and erosion calculations associated with the at least one DME.

6. The system of claim 4, wherein the central database is configured to send job information to a remote device.

7. A method of tracking the use of DME, comprising:
providing a DME;
associating a unique identifier with the DME;
reading the unique identifier with an identifier tag reader;
sending the unique identifier to a central database; and
storing the unique identifier in the central database.

8. The method of claim 7, further comprising:
providing a pumping unit configured to pump fluid through the DME;
associating a pumping unit identifier with the pumping unit;
reading the pumping unit identifier with the identifier tag reader; and
sending the pumping unit identifier and pumping unit job information to the central database.

9. The method of claim 8, further comprising pumping fluid through the DME.

10. The method of claim 9, further comprising storing in the central database at least one type of information associated with the pumping unit selected from the group consisting of: manifold identification, job start date and time, job end date and time, and pumped fluid type, pressure, amount, and flow rate.

11. The method of claim 9, further comprising computing corrosion and erosion calculations associated with the DME and sending corrosion and erosion calculations to a remote device.

12. The method of claim 7, further comprising storing in the central database at least one type of information associated with the DME selected from the group consisting of:
installation status, installation status date, inspection status, location, and manifold identification.

13. The method of claim 12, further comprising sending installation status information to the central database.

14. The method of claim 7, further comprising sending DME information from the central database to a remote device.

15. The method of claim 10, further comprising sending job information from the central database to a remote device.

16. A system for tracking the use of DME, comprising:
a DME;
an unique identifier associated with the DME;
a reader capable of reading the unique identifier;
a pumping unit configured to pump fluid through the DME;
a pumping unit identifier associated with the pumping unit; and
a central database configured to receive and store the unique identifier from the reader and the pumping unit identifier.

17. The system of claim 16, wherein the central database is further configured to receive and store at least one type of job information selected from the group consisting of: manifold identification, job start date and time, job end date and time, and pumped fluid type, pressure, amount, and flow rate.

18. The system of claim 16, wherein the central database is further configured to receive and store at least one type of DME information from the reader selected from the group consisting of: installation status, installation status date, inspection status, location, and manifold identification.

19. The system of claim 18, wherein the central database is configured to compute corrosion and erosion calculations associated with the DME.

20. The system of claim 18, wherein the central database is configured to send the job information to a remote device.
